(19) United States
(12) Patent Application Publication
(10) Pub. No.: US 2004/0068814 A1
(43) Pub. Date: Apr. 15, 2004

(54) Paint roller apparatus with bar and brush

(76) Inventor: Christopher M. Pyles, San Diego, CA (US)

Correspondence Address: Christopher M. Pyles, 9340 Hillery Dr. #402, San Diego, CA, 92126, US

(21) Appl. No.: 10/271,456

(22) Filed: Oct. 15, 2002

(51) Int. Cl. B05C 17/02

(52) U.S. Cl. 15/114; 15/118; 15/230.11; 15/248.2

(57) ABSTRACT

A paint roller apparatus with bar and brush facilitating the painting of a surface (70) that lies adjacent to another surface that is not to be painted contemporaneously. The apparatus comprises a roller cover (58), a bar (22), a brush (28), and a handle (20). Brush (28) is affixed to bar (22), and bar (22) is connected to a bar arm (34) that is rotatably mounted on handle (20). Bar arm (34) can rotate between a paint loading position and a paint application position. In the paint loading position, bar arm (34) is rotated away from roller cover (58) about an axis that is parallel to the longitudinal axis of roller cover (58). Said roller cover can then be immersed in paint without getting any paint on bar (22). When bar (22) is in the paint application position, substantially perpendicular and adjacent to the longitudinal axis of roller cover (58), said roller cover may be placed in contact with the surface to be painted (70) and painting may begin. A brush (28) of predetermined size, shape, and stiffness is mounted onto bar (22) such that the bristles, or other paint application portion of the brush (28), angle into the edge of the surface to be painted (72) and extend to the edge of the surface to be painted (70), but not onto the adjacent surface (74). In operation, roller (58) applies paint up to a short distance from the edge of the surface (72) and brush (28) then takes some of the paint on the surface (70) and applies it up to the edge (72).

### CROSS REFERENCE TO RELATED APPLICATIONS

This application claims priority of patent application Ser. No. 10/126,157 filed on Apr. 20, 2002 by Christopher M. Pyles entitled “Paint Roller Apparatus with Edging Shield and Brush”.

### STATEMENT REGARDING FEDERALLY SPONSORED RESEARCH AND DEVELOPMENT

Not applicable

### BACKGROUND

1. Field of Invention

The present invention relates generally to the field of painting. A labor-intensive and time-consuming aspect of painting is the job of “edging”, a term commonly used in the field to refer to the application of paint to the edge of one surface, but not onto an adjacent surface at the point where two surfaces meet. Edging is often a required aspect of painting around doorframes, window frames, baseboards, and where a ceiling meets walls.

2. Description of Prior Art

The most common methods of edging are by either masking off areas that are to be unpainted with masking tape, thus protecting them from the application of paint during the painting process, or by using a paintbrush to “cut” a straight line around unpainted surfaces. Both of these methods are very time-consuming and labor-intensive. A device that reduces the amount of time to accurately apply paint up to the edge of one surface, but not onto an adjacent surface, would be extremely desirable.

A number of prior devices have been developed in an effort to reduce the labor-intensive burden of the edging process. One such apparatus is illustrated in the Anderson patent, U.S. Pat. No. 3,623,180. The Anderson device includes a plate that mounts directly onto the roller mechanism and which acts as a shield to prevent the application of paint to an adjacent edge. One edge of the Anderson shield is straight; the straight edge of the shield is pressed flush against the painted surface during the painting process, and the paint shield rotates as necessary to keep the shield flush against the wall while the paint roller applicator (known in the art as a roller cover) applies paint.

The limitation of the Anderson device is that the shield prevents the roller cover from applying paint all the way to the adjacent edge. After a single pass, the Anderson device leaves a thin but noticeable unpainted line around adjacent edges on the surface intended to be painted. A further problem is that repeated passes of the Anderson device cause paint to spread and seep under the paint shield and inadvertently spread to the adjacent unpainted surface.

The Deck patent, U.S. Pat. No. 3,369,269, is a similar device developed in recognition of the need to direct and control the application of paint all the way to the edge of the painted surface, including the area under the bottom edge of the shield. The Deck apparatus utilizes a thin line of bristles that are sandwiched between two shield plates and protrude beyond the bottom edges of the shield plates and are configured in a narrow line approximately the same width as the thickness of the shield. The Deck apparatus also utilizes a handle with two arms, one of which attaches to a roller cover, and another that attaches to a shield.

One limitation of the Deck apparatus is due to the placement of the bristles. Since the bristles protrude directly from and along an edge of the shield, the length of the bristles has to be short. Short bristles lack the flexibility that longer bristles have, and the lack of flexibility hinders the smooth and controlled application of paint. Instead, the short bristles apply a noticeably thinner layer of paint near the edge that repeated passes of the device do not rectify. Another limitation is that, like the Anderson patent, the shield blocks paint from getting to the edge of the surface to be painted. Furthermore, since the brush is composed of a thin line of bristles running parallel to the plane of the shield plate, it is difficult to transfer enough paint to the desired location where edges meet in corners. Another limitation is that if any bristles are attached to the edge of the paint shield at a location that prevents the shield edge from sitting flush with the wall surface, the bristles facilitate uncontrolled seepage under the shield to the adjacent surface.

Another apparatus is illustrated in the Burns patent, U.S. Pat. No. 5,623,740. The Burns device, like the Anderson device, utilizes a two-armed handle in which one arm attaches to the roller cover and the other arm attaches to the shield. The Burns device includes a means by which the roller cover can either be rotated parallel to the shield in order to load the roller cover with paint, or removed from the other portion of the handle and then reassembled. After the roller cover is loaded with paint, it is rotated perpendicular to the shield and the shield provides some degree of protection from the unwanted application of paint on an adjacent surface. While the features of the Burns apparatus provide for more efficient “reloading” of paint than the Anderson apparatus, the Burns device has the same fundamental deficiency of the Anderson device in that the shield prevents paint from getting directly to the edge of the surface to be painted. The apparatus leaves a thin but noticeable unpainted line around adjacent edges on the surface intended to be painted, and, as with the Anderson apparatus, repeated passes of the Burns apparatus causes paint to seep uncontrollably under the shield to the edge of the painted surface, and smear unintentionally on the adjacent surface. The problem of excessive seepage is practically unavoidable.

### SUMMARY

The present invention is an apparatus that is useful for painting along the edge of a surface to be painted that lies adjacent to another surface that is not to be painted contemporaneously. The invention resides in the unique configuration of a roller, a bar, a brush, and a handle into a single paint application apparatus. A bar rather than a shield is sufficient because there is no need to block paint from getting on trim or other adjacent surfaces since the roller does not need to be placed as close to the adjacent surface as in the prior art. Rather, the addition of a brush allows for a gap between the roller cover and the adjacent surface thus eliminating the need for a shield and thereby eliminating paint smearing between the shield and the adjacent surface. The bar can be of any predetermined shape and size. The brush of predetermined size, shape, and stiffness is attached to the bar in such a way as to have unhindered access to the edge of a surface to be painted. The brush is mounted onto the bar at a predetermined angle such that the bristles, or other paint application portion of the brush, extend to the edge of the surface to be painted, but not onto the adjacent surface. The bar is rotatably affixed to a bar arm, which allows the apparatus to be easily used on both the left and right sides of doorframes and window frames. The bar arm is rotatably affixed to a handle which allows for the easy loading of paint onto the roller cover while protecting the bar and brush assembly from paint.

In operation, the roller applies the paint up to a short distance from the edge of the surface to be painted and the brush then takes some of the paint and applies it accurately to the edge unhindered by the bar. The roller is affixed to the handle with a separate roller arm. The bar arm can be rotated to a position away from the roller so that the roller can be immersed in paint without getting any paint on the bar, the brush, or the bar arm.

### OBJECTS AND ADVANTAGES

A primary object and/or advantage of the present invention is to combine the speed of a paint roller with the precision of a paint brush to apply paint quickly and accurately up to the edge of a surface without any spillover of paint onto an adjacent surface, and without the need to apply tape to the adjacent surface to protect against leakage or an accidental spillover.

It is another object and/or advantage of the present invention to make the features of the apparatus easily reversible so that the roller mechanism can paint with the brush either on the left side or the right side of the roller cover.

It is another object and/or advantage of the present invention to eliminate the smearing of paint between a shield and an adjacent surface by eliminating the shield.

Other objects and/or advantages of the present invention will become apparent from a reading of the Specification and claims.

### DRAWING FIGURES

FIG. 1 is a perspective view of a first embodiment of the present invention illustrating its use in painting a wall surface adjacent a trim piece such as a doorframe, or window frame.

FIG. 2 is another perspective view similar to FIG. 1 showing the other side of the bar to more clearly show the bar and brush configuration.

FIG. 3 is another perspective view of the embodiment illustrated in FIG. 1 showing the bar and brush in the raised position that is used for loading paint onto the roller.

FIG. 4 is a view parallel to the handle further illustrating the brush and brush holder configuration.

FIGS. 5A to 5C present a birds eye view showing how the flexible projection creates space for the brush when changing the roller's direction of movement.

FIG. 6 is a perspective view of showing the bar arm and bar fixed in relation to each other instead of being rotatably connected.

FIGS. 7A to 7C present side views parallel to the longitudinal axis of the roller cover showing alternative configurations of the bar and brush.

FIGS. 8A and 8B are birds eye views showing the alternative methods of rotating the bar arm.

FIGS. 9A to 9C present top and side views showing alternative methods of rotating the roller cover arm.

FIGS. 10A to 10C show various kinds of brushes that can be used.

### REFERENCE NUMERALS IN DRAWINGS

| | |
|---|---|
| 20 | Handle |
| 22 | Bar |
| 24 | Bar connector |
| 26 | Flexible projection |
| 28 | Brush |
| 30 | Brush holder |
| 32 | Brush handle |
| 34 | Bar arm |
| 36 | Bar arm connector |
| 38 | Locking screw |
| 42 | Top edge of bar |
| 44 | Bottom edge of bar |
| 46 | Front edge of bar |
| 48 | Rear edge of bar |
| 50 | Inside face of bar |
| 52 | Outside face of bar |
| 54 | Wall wheel |
| 55 | Front trim wheel |
| 56 | Rear trim wheel |
| 58 | Roller cover |
| 60 | Roller cover end |
| 61 | Roller cover arm connector |
| 62 | Roller cover arm |
| 64 | Locking plate |
| 66 | Locking tab |
| 68 | Threaded opening |
| 70 | Surface to be painted |
| 72 | Edge of surface to be painted |
| 74 | Adjacent surface |

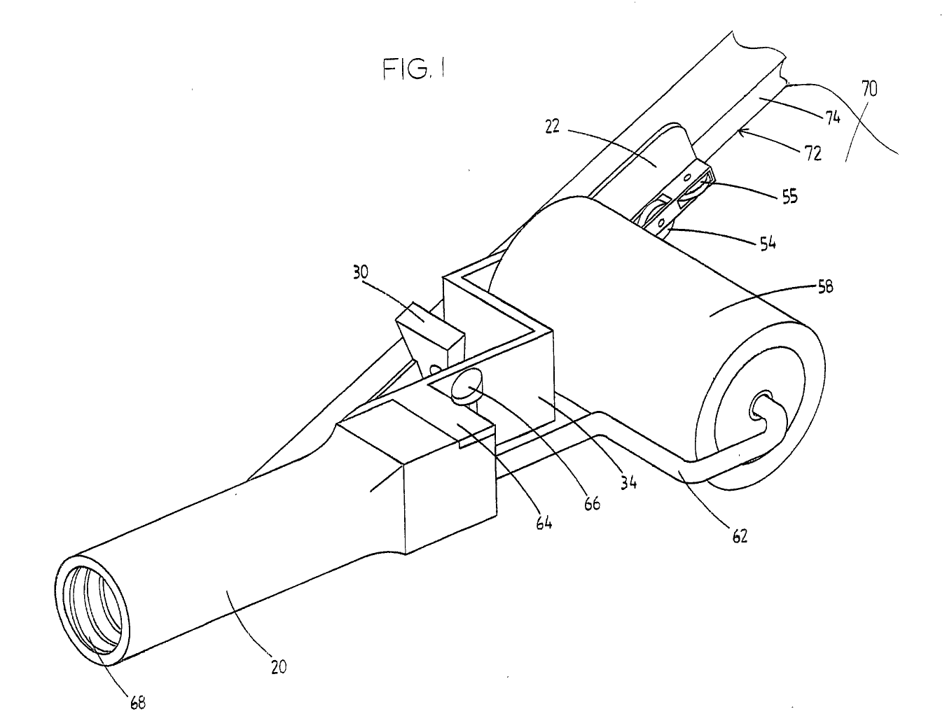

### DESCRIPTION—FIGS. 1 to 5—PREFERRED EMBODIMENT

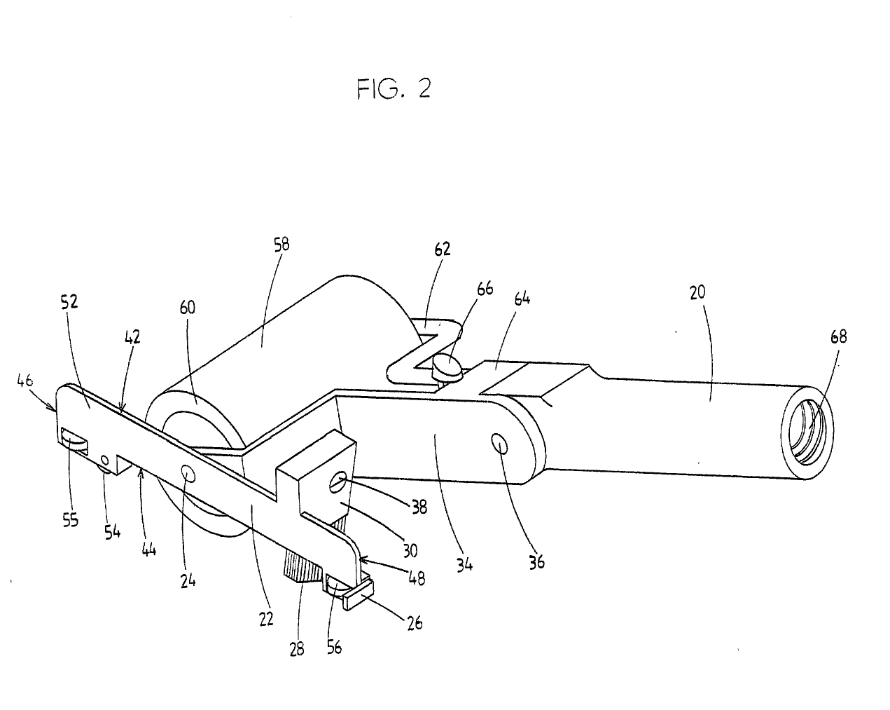

FIGS. 1 and 2 show the preferred embodiment of a painting apparatus in a paint application position comprising a handle (20), roller cover (58), and bar (22) with brush (28). Handle (20) has a longitudinal axis. In the preferred embodiment, said handle has a threaded opening (68) at its base to allow a user to attach a pole if desired. In the paint application position, bar (22) is substantially perpendicular to roller cover (58) and adjacent to roller cover end (60).

FIGS. 1 to 3 also show that handle (20) is supporting both roller cover (58) and bar (22) by means of support arms (62) and (34) and connected respectively thereto. Roller cover arm (62) is a round metal shaft that is bent substantially perpendicular to the longitudinal axis of handle (20). Roller cover arm (62) is fixed with one end glued or otherwise fixed into a matching hole in handle (20). Roller cover (58) is then slipped onto the unattached end of said shaft and is free to rotate about its' longitudinal axis.

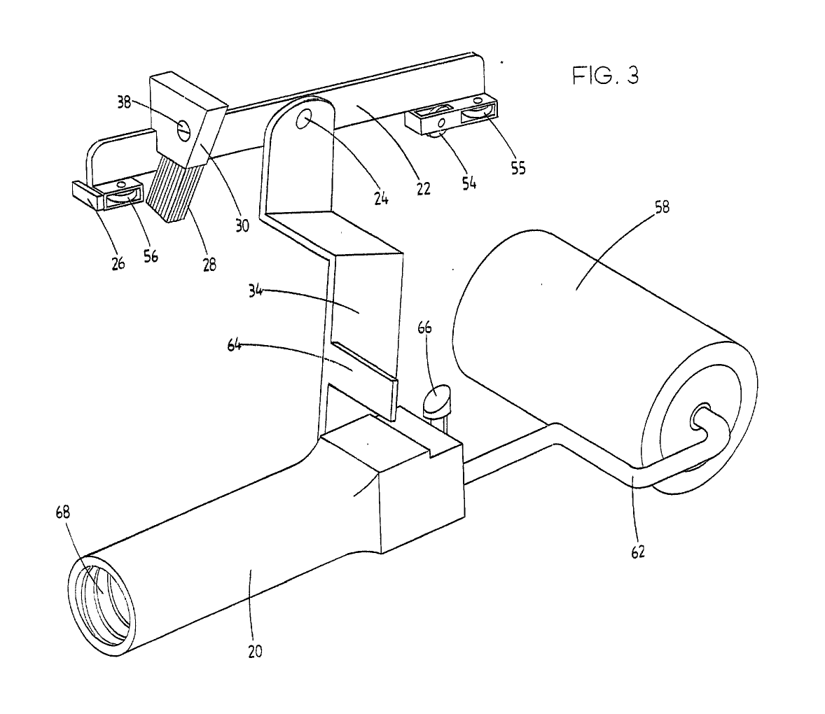

FIG. 2 shows that bar arm (34) is connected to handle (20) by means of a bar arm connector (36). Connector (36) allows rotation of bar arm (34). The axis of said rotation is substantially perpendicular to the longitudinal axis of handle (20) and substantially parallel to the longitudinal axis of roller cover (58). FIGS. 1 and 2 show different views of bar arm (34) when it is in the paint application position. Bar arm (34) can then be locked in this position with a locking tab (66). FIG. 3 shows bar arm (34) rotated approximately 90 degrees up and away from roller cover (58) in a paint loading position to facilitate the loading of paint thereon.

FIGS. 1 to 3 also show a bar arm locking means. This locking means includes a locking tab (66) that is connected on one end to handle (20) and is free to bend on the other end when pressure is applied to it by a user's finger or thumb. Locking tab (66) also exhibits memory such that locking tab (66) returns to its original position when said pressure is removed. A locking plate (64) is affixed to bar arm (34) such that in the paint application position, locking tab (66) covers locking plate (64) and prevents movement thereof. When said pressure is applied to locking tab (66), bar arm (34) is released and free to rotate up and away from roller cover (58).

As shown in FIGS. 2 and 3, bar arm (34) is rotatably connected to bar (22). FIGS. 1 to 3 also show that bar (22) is comprised of a primarily flat, rectangular shaped plate with an inside face (50), outside face (52), front edge (46), rear edge (48), top edge (42), and bottom edge (44). Bar (22) is a plate approximately 0.2 centimeters thick, approximately 18 centimeters in length, and approximately 1 centimeter in height, but these measurements may vary depending on the material used for said bar, the size of the roller cover used, and the requirements of the user. Furthermore, in the paint application position, said bar is positioned substantially parallel to and above a surface to be painted (70) such that the bottom edge of the bar (44) is approximately 1 centimeter above said surface to be painted. This allows the bristles of brush (28) to distribute paint under bar (22) all the way to an edge (72).

FIGS. 2 and 3 clearly show that bar (22) also has two trim wheels (55 and 56) that protrude approximately 0.3 centimeters from the outside face (52) of said bar. Both trim wheels (55 and 56) are located under bar (22) with front trim wheel (55) located at front edge (46) and rear trim wheel (56) located at rear edge (48). In the paint application position, both trim wheels (55 and 56) rotate on axes that are substantially perpendicular to the plane of the surface to be painted (70) such that said trim wheels roll on an adjacent surface (74). Said trim wheels act as guides to prevent bar (22) from contacting adjacent surface (74) that is not to be painted and thus prevent scraping and marking thereof and also act to position brush (28) correctly in relation to the edge of the surface to be painted (72). To prevent the bottom sides of said trim wheels from scraping the surface to be painted (70), a wall wheel (54) is fixed to the bottom of bar (22). In the paint application position, the axis of rotation of wall wheel (54) is substantially parallel to the longitudinal axis of roller cover (58). In the preferred embodiment, wall wheel (54) would be placed near one end of bar (22) and brush (28) would be placed near the other end.

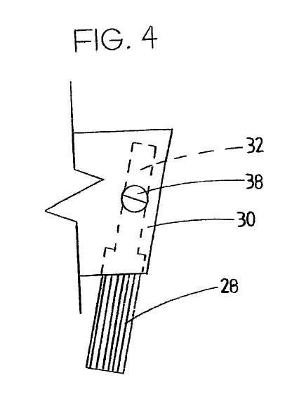

FIG. 4 shows more detail about the placement of brush (28). Said brush is mounted onto bar (22) at a predetermined angle such that the bristles of brush (28) are angled into the edge of the surface to be painted (72). Brush (28) has a handle (32) having a predetermined shape that slides into a matching hole on a brush holder (30) and locked into place by a locking screw (38). FIG. 4 shows with hidden lines brush handle (32) positioned in brush holder (30). Said brush can then be easily adjusted to compensate for wear of the bristles, or be removed completely for cleaning and replacement by loosening locking screw (38). Alternatively, brush handle (32) can be made to frictionally fit into brush holder (30) without the need for locking screw (38). Said brush (28) extends past bottom edge (44) of bar (22) a predetermined distance in order to urge a proper degree of bending in brush (28) when wall wheel (54) and roller cover (58) are in contact with the surface to be painted (70) in the paint application position, thus allowing said brush to effectively spread paint to the edge of the surface to be painted (72). FIG. 4 also shows that in the preferred embodiment, brush (28) is a flat brush.

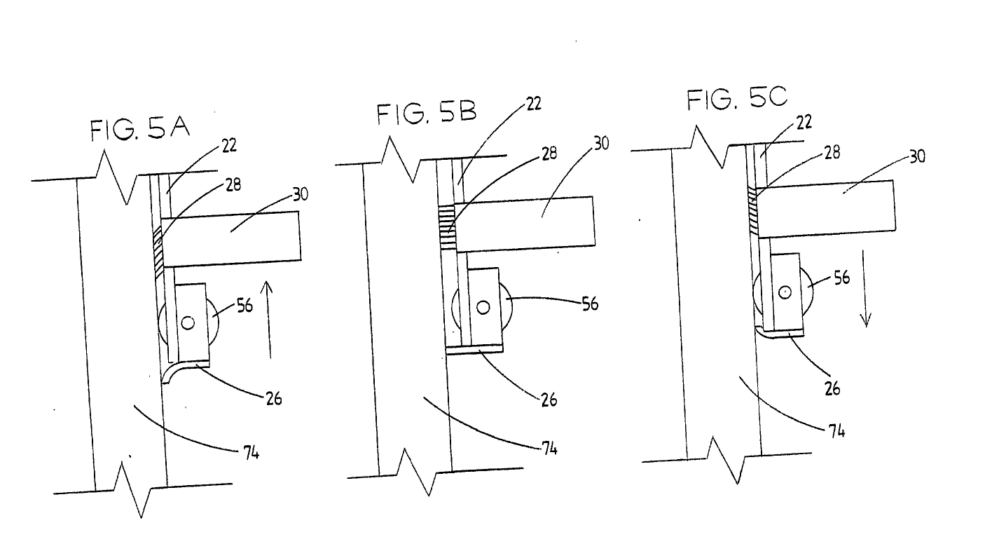

FIGS. 5A to 5C show how a flexible projection (26) creates space between brush (28) and adjacent surface (74) when the user rolls the apparatus back and forth on the surface to be painted (70). Flexible projection (26) projects past the outside face (52) of said bar a predetermined amount and is mounted substantially near brush (28). FIG. 5A shows how flexible projection (26) bends out of the way and lets rear trim wheel (56) contact adjacent surface (74) when the apparatus is rolled in one direction thereby allowing the flexed bristles of brush (28) to reach the edge of the surface to be painted (72). When the direction is reversed, said bristles have a natural tendency to get jammed too close to the adjacent surface (74) due to the arc-like movement of said bristles as they switch and bend in the opposite direction. FIG. 5B shows flexible projection (26) creating space between adjacent surface (74) and bar (22) as flexible projection (26) sweeps in an arc and thereby allowing bristles of brush (28) to sweep through an arc without getting paint on adjacent surface (74). FIG. 5C shows the completed direction change and shows brush (28) and flexible projection (26) bending in the opposite direction from FIG. 5A.

In a preferred embodiment of brush (28), the width of said brush is approximately 15 millimeters in order to move enough paint to the edge of the surface to be painted (72), but any size brush can be used as long as the required results are obtained. The preferred material for said brush is nylon or polyester, or some combination of the two. However, other materials may be used such as natural hairs, or even foam depending on the type of paint to be applied.

In the preferred embodiment, bar arm (34) would be constructed of a hard rigid plastic, but, clearly, any material that has sufficient strength and rigidity to support bar (22) can be used. Likewise, said bar can be made of any suitably rigid and shatter-resistant material. The preferred material would be a hard rigid plastic that meets these requirements. Alternatively, metal may be a preferred material for bar (22) and bar arm (34) for outdoor paint applications to better withstand the rigors of contacting rough exterior surfaces.

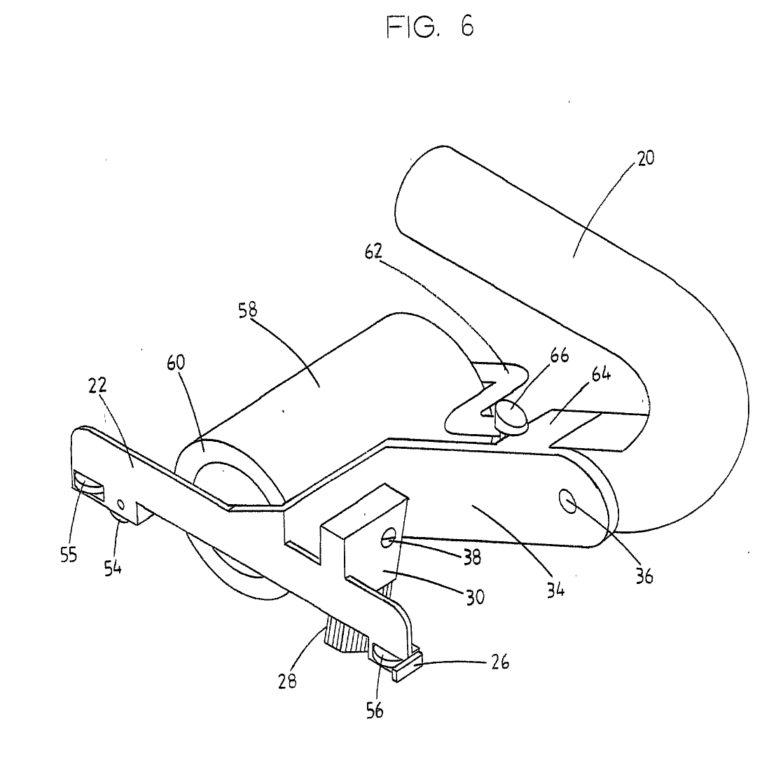

FIGS. 6 to 10—Alternative Embodiments

FIG. 6 shows that an alternative to the pivoting bar of the preferred embodiment is a bar that is fixed to the bar arm. In this alternative embodiment, the handle could be bent back over the roller cover to form a V or U-shaped handle in order to facilitate the reversing of the apparatus to paint both sides of a doorframe, or window frame. FIG. 6 also shows that in this alternative embodiment the brush could be mounted on the bar or the bar arm. This is feasible since the bar and bar arm are fixed relative to each other. In fact, the brush could even be mounted on the handle, if the bar arm, bar, and handle were all fixed relative to each other. In this case, the roller cover arm would rotate between a paint application position and a paint loading position instead of the bar arm.

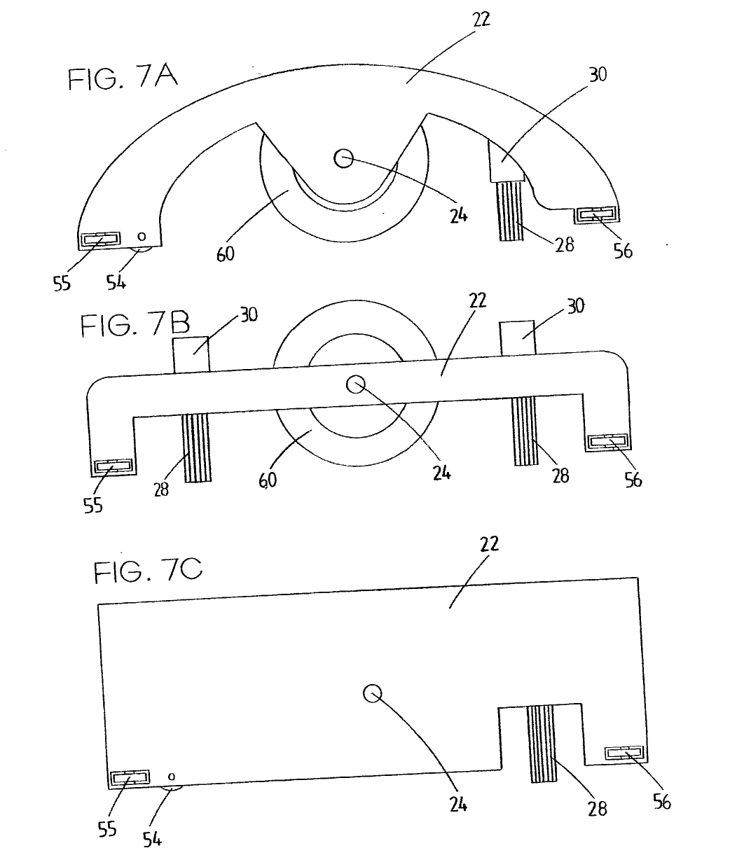

FIGS. 7A to 7C show that the bar can take many shapes other than the rectangular bar of the preferred embodiment. FIG. 7A shows that the bar can be curvilinear instead of straight. FIG. 7B shows that more than 1 brush can be used in the same apparatus. FIG. 7C shows that the bar can even be stretched out into a plate or shield shape. Other shapes are clearly possible. For example, the bar can be made of a suitably stiff cylindrical shaft, which can be bent to different shapes that would work equally well as the preferred embodiment.

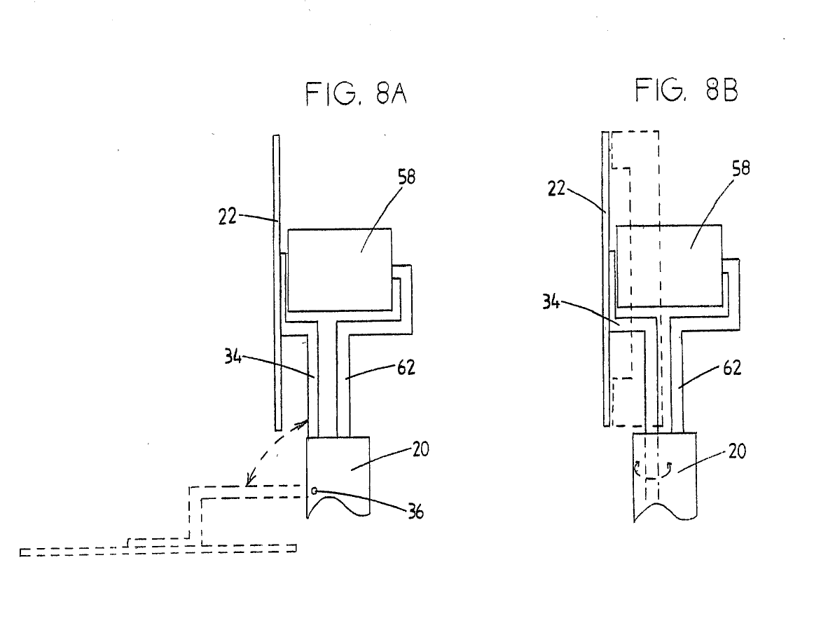

FIGS. 8A to 8B present birds eye views of the bar and roller cover in the paint application position and show alternative embodiments that deal with various methods of rotating the bar arm. FIG. 8A shows that the bar arm can be rotated on an axis substantially perpendicular to the longitudinal axis of the handle and substantially perpendicular to the longitudinal axis of the roller cover. FIG. 8B shows that the bar arm can be rotated on an axis substantially parallel to the longitudinal axis of the handle such that the bar's plane of rotation is substantially parallel to the longitudinal axis of the roller cover. In this embodiment, the bar and brush unit rotates up and over the roller cover instead of away from it as in the preferred embodiment.

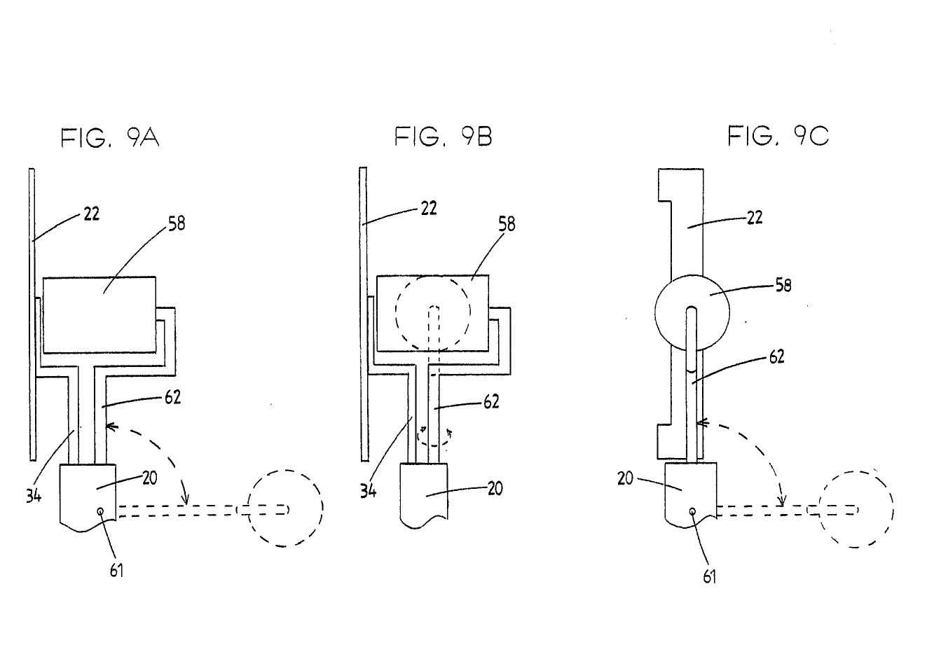

FIGS. 9A to 9C show that the roller arm can be rotated instead of the bar arm to accomplish the same purpose of creating distance between the roller cover and the bar in order to facilitate the loading of paint onto the roller cover. There are many other ways to rotate the bar arm and roller arm that are not expressly mentioned here, but are within the scope of the claims that follow.

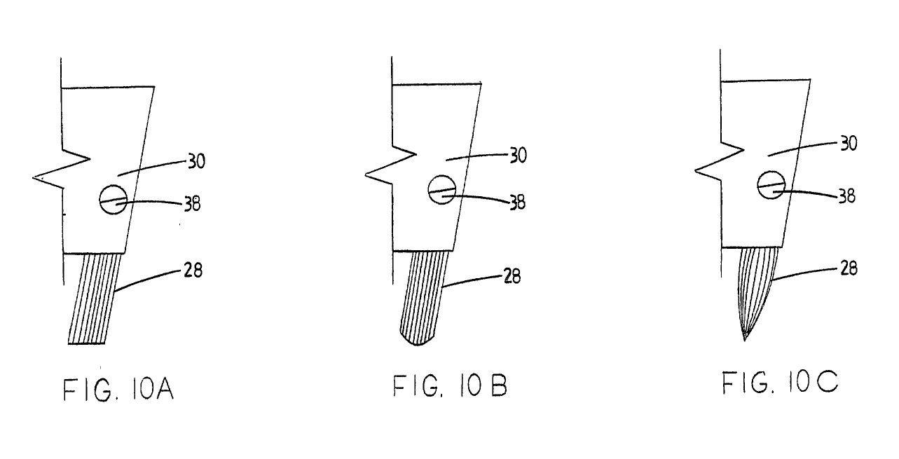

FIGS. 10A to 10C present end views perpendicular to the longitudinal axis of the roller cover and show different brush shapes that can be used. FIG. 10A shows an angled brush rather than the flat brush of the preferred embodiment; FIG. 10B shows a flat oval shaped brush known in the art as a filbert; and FIG. 10C shows a round brush.

The trim wheels can also be replaced by non-rotating tabs that slide against said adjacent surface instead of roll, in which case said tabs would be made of a non-marking material to prevent scuffing and marking on adjacent surface. Likewise, non-rotating tabs that slide against said surface to be painted can replace the one or more wall wheels.

Advantages

From the description above, a number of advantages of my apparatus become evident:

(a) the apparatus reduces the amount of time required to paint surface edges;

(b) the apparatus simplifies the painting process for all painters;

(c) the apparatus enables the user to paint a straighter edge than the devices of the prior art;

(d) the addition of a brush provides a means for applying paint all the way to the edge of the surface to be painted faster than with other existing methods;

(e) the brush mounted to a bar provides for greater control and accuracy of the spread of paint to the edge of the surface being painted;

(f) the addition of a brush to the bar eliminates the need for the roller cover to be pressed as close to the bar as was required in the prior art, a feature that allows the roller cover to rotate more easily along the surface to be painted;

(g) the addition of wheels to the bar allows for smooth operation even on rough surfaces;

(h) the rotation of the bar away from the roller cover allows for either vertical or horizontal immersion of said roller cover into a source of wet paint without getting wet paint on the bar mechanism;

(i) the addition of a flexible projection on the bar prevents the brush from getting paint on the adjacent surface when the user changes the apparatus' direction; and

(j) the elimination of a shield eliminates the problem of paint smearing between the shield and the adjacent surface.

Operation—FIGS. 1 to 3

The manner of using this paint roller apparatus with bar and brush is similar to that for paint rollers in present use. The only difference is that the user of this apparatus has to first correctly position bar (22) in one of two positions: the paint application position, or the paint loading position. In the paint application position (FIGS. 1 and 2), bar (22) is down and substantially perpendicularly adjacent to roller cover (58). In the paint loading position (FIG. 3), bar (22) is up and away from roller cover (58). To move said bar from one position to the other the user has to first depress locking tab (66) away from locking platform (64) with a finger or thumb to release bar arm (34). Bar arm (34) can then be manually raised or lowered. When bar (22) is up, it will stay in place due to friction caused by a bar arm connector (36). To lower bar (22) into the paint application position, the user merely has to rotate bar arm (34) into position and locking tab (66) will automatically lock said bar arm in place by means of said memory exhibited by said locking tab.

To load roller cover (58) with paint, the user has to first make sure bar (22) is in the paint loading position. The user can then dip roller cover (58) into paint that is in a paint tray or a paint bucket in the traditional method. Once roller cover (58) is sufficiently loaded with paint, bar arm (34) is rotated into the paint application position and locking tab (66) automatically locks said bar arm in place. Once bar (22) is in the paint application position, the painting operation can commence. To start painting, trim wheels (56) are placed in contact with the adjacent surface (74) such that the longitudinal axis of roller cover (58) is substantially perpendicular to said adjacent surface and such that wall wheel (54) and roller cover (58) contact surface to be painted (70). The apparatus is then rolled up and down the surface to be painted (70) keeping trim wheels (56) flush with adjacent surface (74). This action is continued until roller cover (58) expends the paint and needs to be reloaded with paint. When this happens, locking tab (66) is deflected open, bar arm (34) is rotated out of the way, and the paint loading operation is repeated.

### CONCLUSION, RAMIFICATIONS AND SCOPE

Accordingly, the reader will see that the roller brush apparatus of this invention can be used to significantly reduce the amount of time needed to paint the walls of a room. In addition, this apparatus greatly simplifies the process of edging such that even a novice painter can paint quickly and accurately around surfaces that are not to be painted such as doorframes and window frames. Furthermore, the roller brush apparatus has additional advantages in that

it permits the user to paint exactly up to the edge of a surface to be painted by having a brush affixed to a bar adjacent to the roller cover which applies the paint deposited by the roller cover up to the edge without getting paint on the adjacent surface;

it eliminates the problem of paint seeping under a shield and smearing on an adjacent surface by providing a brush which eliminates the need for a shield;

it reduces the amount of time needed to trim a room by eliminating the need to tape around objects not to be painted, or trim around them with a brush;

it permits easier rotation of the roller cover along the surface to be painted by eliminating the need for the roller cover to be pressed tightly against a shield, thus reducing rotating friction;

Although the description above contains many specificities, these should not be construed as limiting the scope of the invention, but as merely providing illustrations of some of the presently preferred embodiments of this invention. It is specifically stated that the present invention is not limited to any overall dimensions. For example, said roller cover can be less than four inches long to the more conventional nine-inch length; the diameter of the roller cover can be of any functional size; the bar can be trapezoidal, triangular, semi-circular, or completely curvilinear as shown in FIG. 8C; the wall wheel on the bar can consist of one or more wheels; and the trim wheels on the bar can also consist of a plurality of wheels. Furthermore, it is stated that the present invention is not limited to any material, so long as the material accomplishes the required task.

Thus the scope of the invention should be determined by the appended claims and their legal equivalents, rather than by the examples given.

I claim:

1. A paint application apparatus used to apply paint along an edge of a surface to be painted, but not on an adjacent surface, comprising:
a) a paint applicator roller cover of predetermined size having a longitudinal axis;
b) a bar of predetermined form;
c) a handle having a longitudinal axis and connected to two arms: a roller arm that rotatably connects to said roller cover such that said roller cover is at an angle substantially perpendicular to said longitudinal axis of said handle, and a bar arm which rotatably connects to said bar such that in a paint application position said bar is positioned substantially perpendicularly adjacent to said roller cover; and
d) at least one brush and means for attaching said brush to said paint application apparatus.

2. A paint application apparatus as in claim 1, wherein the paint applicator portion of said brush may be made of any type of material.

3. A paint application apparatus as in claim 1, wherein said brush is affixed to said bar at a predetermined angle such that in the paint application position the tip of said paint applicator portion of said brush reaches to the edge of said surface to be painted.

4. A paint application apparatus as in claim 3, further including a means for removing and replacing said brush from said bar.

5. A paint application apparatus as in claim 1, wherein said paint applicator portion of said brush is positioned such that in said paint application position, contact with said surface to be painted urges said paint applicator portion to bend a predetermined amount.

6. A paint application apparatus as in claim 1, further including a flexible projection of predetermined form connected at a predetermined location to said bar.

7. A paint application apparatus as in claim 1, further including one or more projections of predetermined shape connected to said bar, which projections in said paint application position shall slide against said adjacent surface.

8. A paint application apparatus as in claim 7, wherein said projections roll rather than slide on said adjacent surface.

9. A paint application apparatus as in claim 1, further including a means of rotatably connecting said bar arm to said handle such that said bar arm rotates in a predetermined manner away from said roller cover, thereby facilitating the loading of paint thereof.

10. A paint application apparatus as in claim 9, further including a means of locking and unlocking said bar arm into said paint application position.

11. A paint application apparatus as in claim 1, further including a means of rotatably connecting said roller arm to said handle whereby said roller arm rotates in a predetermined manner away from said bar arm, thereby facilitating the loading of paint on said roller cover.

12. A paint application apparatus as in claim 11, further including a means of locking and unlocking said roller arm into said paint application position.

13. A paint application apparatus used to apply paint along an edge of a surface to be painted but not on an adjacent surface, comprising:
a) a paint applicator roller cover of predetermined size with a longitudinal axis;
b) a bar of predetermined form;
c) a handle having a longitudinal axis and connected to two arms: a roller arm that rotatably connects to said roller cover such that said roller cover is at an angle substantially perpendicular to said longitudinal axis of said handle, and a bar arm which is rigidly affixed to said bar such that in a paint application position said bar is positioned substantially perpendicularly adjacent to said roller cover; and
d) at least one brush and means for attaching said brush to said paint application apparatus.

14. A paint application apparatus as in claim 13, wherein the paint applicator portion of said brush may be made of any material.

15. A paint application apparatus as in claim 13, wherein said brush is affixed to said bar at a predetermined angle such that in the paint application position the tip of said paint applicator portion of said brush reaches to the edge of the surface to be painted.

16. a paint application apparatus as in claim 13, wherein said brush is affixed to said bar arm at a predetermined angle such that in the paint application position the tips of a portion of said bristles reach to the edge of the surface to be painted.

17. A paint application apparatus as in claim 13, wherein said brush is affixed to said handle at a predetermined angle such that in the paint application position the tip of said paint applicator portion of said brush reaches to the edge of the surface to be painted.

18. A paint application apparatus as in claim 13, further including a means for removing and replacing said brush from said paint application apparatus.

19. A paint application apparatus as in claim 13, wherein said paint applicator portion of said brush is positioned such that in said paint application position, contact with said surface to be painted urges said paint applicator portion to bend a predetermined amount.

20. A paint application apparatus as in claim 13, further including a flexible projection of predetermined form connected at a predetermined location to said bar.

21. A paint application apparatus as in claim 13, further including one or more projections of predetermined shape on said bar, which projections in the paint application position shall slide against said adjacent surface.

22. A paint application apparatus as in claim 21, wherein said projections roll rather than slide on said adjacent surface.

23. A paint application apparatus as in claim 13, further including a means of rotatably connecting said bar arm to said handle such that said bar arm rotates in a predetermined manner away from said roller cover to facilitate the loading of paint thereof.

24. A paint application apparatus as in claim 23, further including a means of locking and unlocking said bar arm into said paint application position.

25. A paint application apparatus as in claim 13, further including a means of rotatably connecting said roller arm to said handle whereby said roller arm rotates in a predetermined manner away from said bar arm thereby facilitating the loading of paint on said roller cover.

26. A paint application apparatus as in claim 25, further including a means of locking and unlocking said roller arm into said paint application position.
